(19) United States
(12) Patent Application Publication
(10) Pub. No.: US 2015/0121516 A1
(43) Pub. Date: Apr. 30, 2015

(54) AUTHENTICATING INPUT IN TRUSTED EXECUTION MODE

(71) Applicant: Samsung Electronics Co., Ltd., Gyeonggi-do (KR)

(72) Inventors: Tymur KORKISHKO, Gyeonggi-do (KR); Kyung-Hee LEE, Gyeonggi-do (KR)

(21) Appl. No.: 14/526,859

(22) Filed: Oct. 29, 2014

(30) Foreign Application Priority Data
Oct. 30, 2013 (KR) 10-2013-0130366

(51) Int. Cl. G06F 21/31

(52) U.S. Cl. CPC G06F 21/31
USPC 726/19

(57) ABSTRACT

Disclosed herein are a method and electronic device for enhancing security authentication. An execution mode may be changed from a non-trusted execution mode to a trusted execution mode. At least one input may be authenticated while in the non-trusted execution mode.

### CLAIM OF PRIORITY

The present application claims priority under 35 U.S.C. §119 to an application filed in the Korean Intellectual Property Office on Oct. 30, 2013 and assigned Serial No. 10-2013-0130366, the contents of which are incorporated herein by reference.

### BACKGROUND

1. Technical Field

The present disclosure relates generally to a method for a secure input and an electronic device thereof.

2. Description of the Related Art

The recent advances in multimedia technology have given rise to electronic devices equipped with a variety of functions. In particular, many complex functions now converge into a single device. One such function includes a telecommunications function that has given rise to mobile terminals known as “smartphones.” A mobile terminal may include a display module with a large touch screen and a high pixel camera module in addition to basic functions. A camera module allows the mobile terminal to photograph a still image and a moving image. In addition, a mobile terminal is able to reproduce multimedia content such as music, video, etc., and is able to access a network, such as the Internet.

The performance of these electronic devices have been enhanced with the inclusion of a high performance processor. Therefore, such electronic devices are able to provide these additional services due to the rapid development of hardware, such as application processors (AP), and operating systems (OS). For example, the electronic device can provide an improved banking service to enable an electronic payment which require security information exchanges to prevent hacking of personal information.

### SUMMARY

Accordingly, an aspect of the present disclosure provides a method and electronic device for secure input, which operates a trusted execution environment and a non-trusted execution environment of the electronic device. Another aspect of the present disclosure provides a method and electronic device for secure input that may prevent an electronic device from being hacked by external devices. The present disclosure further provides a user interface that may be used to execute secure authentication of at least one user input.

In yet another aspect of the present disclosure, a method for controlling an electronic device may include: displaying a user interface for authentication while in a non-trusted execution mode; changing an execution mode of the electronic device to a trusted execution mode; detecting at least one input via the user interface while in the trusted execution mode; and authenticating the at least one user input while in the trusted execution mode.

In a further aspect of the present disclosure, an electronic device may include at least one processor to: display a user interface for authentication while in a non-trusted execution mode; change an execution mode of the electronic device to a trusted execution mode; detect at least one input via the user interface while in the trusted execution mode; and authenticate the at least one user input while in the trusted execution mode. In another example, the at least one processor may be further configured to arrange some of the input areas in a fixed pattern and arrange some of the input areas in a sequential or random pattern.

The aspects, features and advantages of the present disclosure will be appreciated when considered with reference to the following description of examples and accompanying figures. The following description does not limit the application; rather, the scope of the disclosure is defined by the appended claims and equivalents.

### BRIEF DESCRIPTION OF THE DRAWINGS

As noted above, the advantages of the present disclosure will become more apparent from the following detailed description when taken in conjunction with the accompanying drawings in which:

FIG. 1 is a perspective view of an example electronic device in accordance with aspects of the present disclosure;

FIG. 2A is a block diagram of an example electronic device in accordance with aspects of the present disclosure;

FIG. 2B is a block diagram of an example processor in accordance with aspects of the present disclosure;

FIG. 3A and FIG. 3B are working examples in accordance with aspects of the present disclosure;

FIG. 4A, FIG. 4B, FIG. 4C and FIG. 4D are additional working examples in accordance with aspects of the present disclosure;

FIG. 5 is a flowchart illustrating an example method in accordance with aspects of the present disclosure; and

FIG. 6A is a flowchart illustrating a further example method in accordance with aspects of the present disclosure; and

FIG. 6B is a flowchart illustrating yet another example method in accordance with aspects of the present disclosure.

### DETAILED DESCRIPTION

Various examples of the present disclosure will be described herein with reference to the accompanying drawings. For the purposes of clarity and simplicity, details of well-known functions or configurations will be omitted as they would obscure the subject matter of the present disclosure. Also, terms used herein may be defined in accordance with the functions of the present disclosure. Therefore, the terms should be understood based on the following description.

An electronic device to which a display device is applicable as a display is illustrated and explained. However, this should not be considered as limiting. For example, the electronic device may be applied to various devices including a display device, that is, a Personal Digital Assistant (PDA), a laptop computer, a mobile phone, a smartphone, a net book, a TV, a Mobile Internet Device (MID), an Ultra Mobile PC (UMPC), a tablet PC, a watch, a camera device, a navigation device, an MP3 or wearable device, etc.

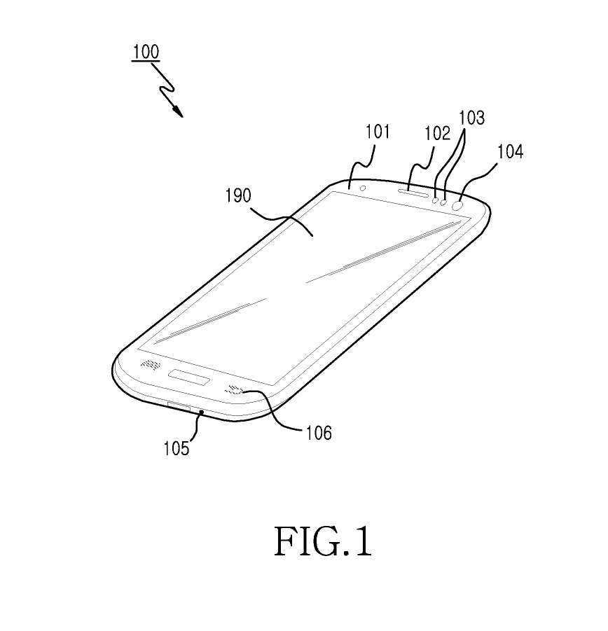

Referring now to the example of FIG. 1, the example electronic device 100 includes a display device 190 installed on a front surface 101 thereof. The display device 190 may display an electric signal transmitted from the electronic device 100 as an image such as a text, a graphic, a video, etc. In addition, the display device 190 may be implemented by using a touch screen which is capable of data input and output simultaneously by applying a touch sensor technology.

The display device 190 may include an ear piece 102 installed on an upper side thereof to receive a voice, and a plurality of sensors 103 for improvising user convenience, such as a proximity sensor or an luminance sensor, and a camera device 104 for photographing a subject may be disposed in the proximity of the ear piece 102.

The electronic device 100 may further include a microphone device 105 which may be located on a lower side of the display device 190 to receive a sound, and a keypad device 106 on which key buttons are arranged. However, this should not be considered as limiting. The electronic device 100 may include more or less components than those shown in FIG. 1 for performing other functions.

The electronic device 100 may be operated in a Trusted Execution Environment (TEE) or a Non-trusted Execution Environment (NTEE). In one example, the non-trusted execution environment may include, but is not limited to, an operating system used for general system control and management. Such an operating system may include, but it not limited to, the Android™ platform or Linux®. In another example, a trusted execution environment may include, but is not limited to, an operating system that handles processes requiring enhanced security, such as user authentication. The enhanced security of the trusted execution environment may prevent electronic device 100 from being hacked by external devices. The trusted execution environment and non-trusted execution environment may be implemented not only as hardware but also as software.

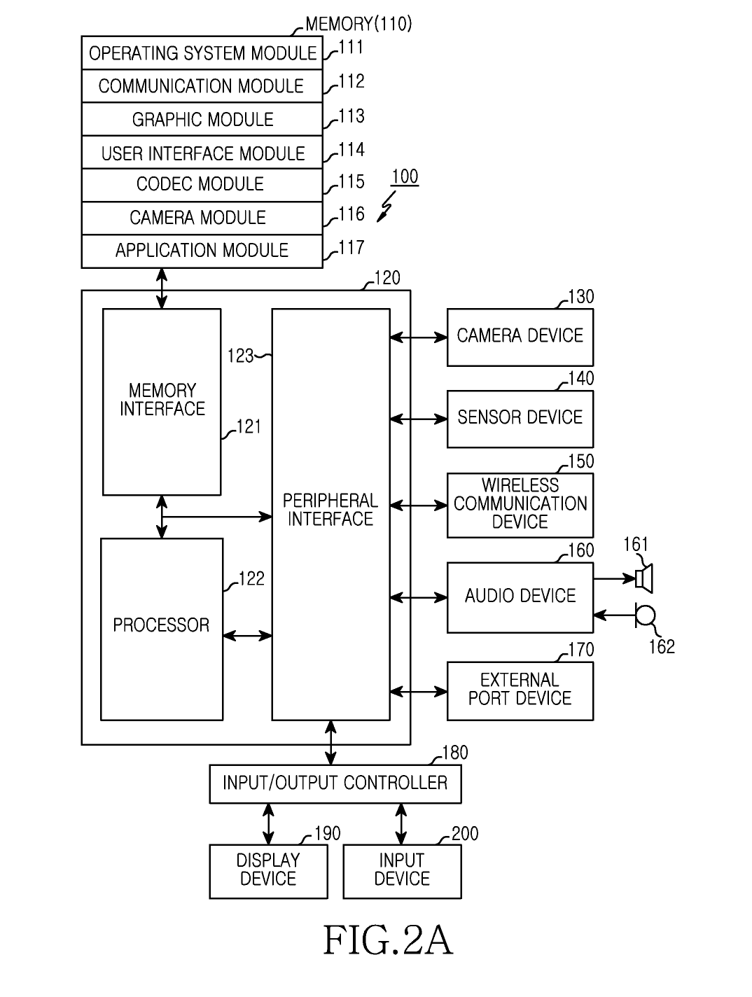

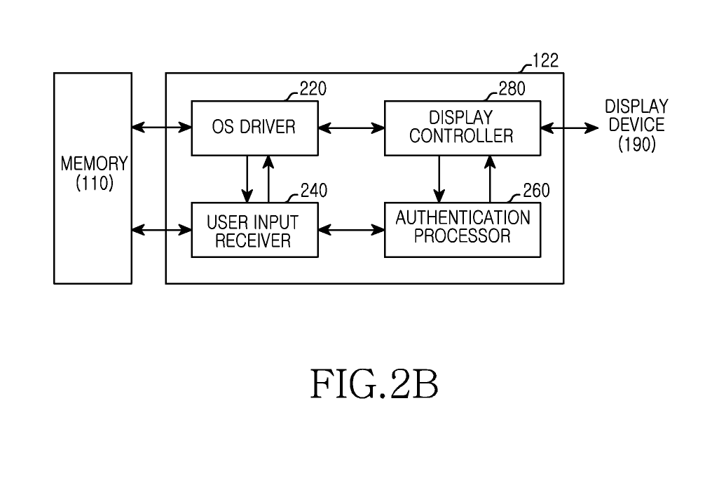

Referring now to the example of FIG. 2A, the electronic device 100 may be a device such as a PDA, a laptop computer, a mobile phone, a smartphone, a net book, a handheld computer, a Mobile Internet Device (MID), a media player, a Ultra Mobile PC (UMPC), a tablet PC, a notebook PC, a watch, a navigation device, an MP3, a camera device or a wearable device. In addition, the electronic device 100 may be any device which includes a device combining two or more functions of the above-mentioned devices.

In another example, the electronic device 100 may include a memory 110, a processor unit 120, a camera device 130, a sensor device 140, a wireless communication device 150, an audio device 160, an external port device 170, an input/output controller 180, a display device 190, and an input device 200. The memory 110 and the external port device 170 may be provided in plural number.

The processor unit 120 may include a memory interface 121, at least one processor 122, and a peripheral interface 123. The memory interface 121, the at least one processor 122, and the peripheral interface 123 included in the processor unit 120 may be integrated into at least one integrated circuit or may be implemented as separate elements. The entirety of the processor unit 120 may be called a processor according to circumstances.

The memory interface 121 may control access of the elements such as the processor 122 or the peripheral interface 123 to the memory 110.

The peripheral interface 123 may control a connection between an input/output peripheral of the electronic device 100 and the processor 122 and the memory interface 121.

The processor 122 may control the electronic device 100 to provide various multimedia services by using at least one software program. The processor 122 may execute at least one program stored in the memory 110 and provide a service corresponding to the program.

The processor 122 may perform various functions for the electronic device 100 by executing various software programs, and may process and control voice communication, video communication, and data communication. In addition, the processor 122 may perform the techniques of the present disclosure by interworking with software modules stored in the memory 110.

The processor 122 may include at least one of a data processor, an image processor, or a COding DECoding (CODEC). Furthermore, the electronic device 100 may include the data processor, the image processor, or the CODEC as separate elements.

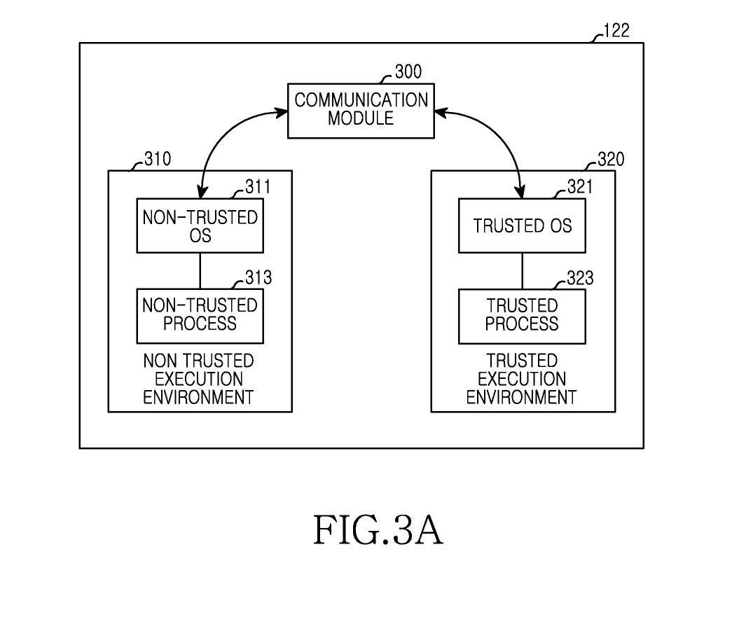

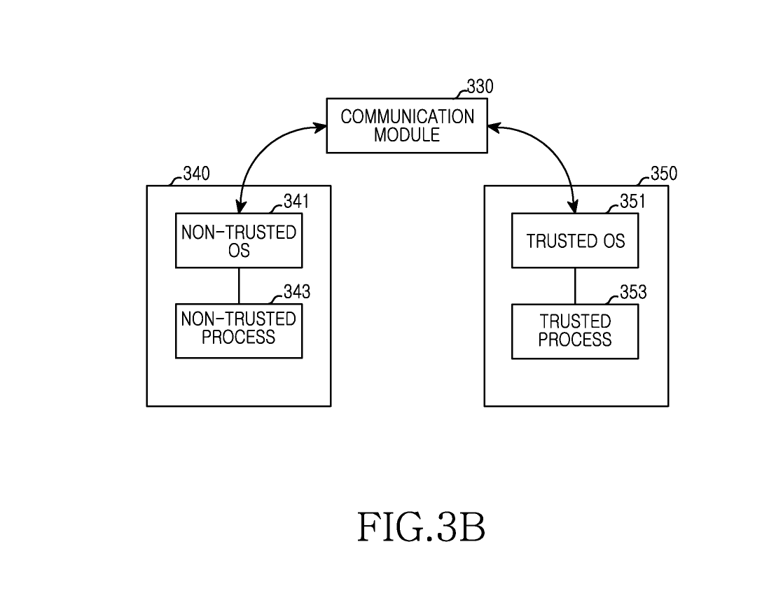

In one example, the processor 122 may authenticate a user input by applying a trusted zone technology. Trusted zone technology is a method for providing two physical spaces, such as a non-trusted area (or a normal world) and a trusted area (or a secure area) to the one processor 122, and allowing an application requiring security to be operated in the trusted area (see FIG. 3A). Generally, in the non-trusted area, an existing open OS such as the Android™ platform, Windows Phone 7, etc. may be operated, and, in the trusted area, a trusted OS of a very small size and an application may be operated. The trusted area may refer to a secure area or a Trusted Execution Environment (TEE), and the non-trusted area may refer to a non-secure area or a Non-trusted Execution Environment (NTEE). The non-trusted execution environment may be an OS such as the Android™ platform or Linux® and may include a Kernel or a driver Integrated Circuit (IC). However, this should not be considered as limiting and the trusted area and the non-trusted area may be expressed as various terms.

In another example, two processors may be operated as a non-trusted area and a trusted area (see FIG. 3B). The trusted area includes a memory area of a small size therein, and the memory area stores security data such as a master key, a certificate, personal information, etc. and thus may be accessed only by a processor of the trusted area and may not be accessed by a processor of the non-trusted area.

The various elements of the electronic device 100 may be connected with one another via one or more communication buses (reference numeral is not shown) or an electric connecting means (reference numeral is not shown).

The camera device 130 may perform a camera function such as photographing, video clipping, recording, etc. The camera device 130 may include a Charged Coupled Device (CCD), a Complementary Metal-Oxide Semiconductor (CMOS), etc. In addition, the camera device 130 may change hardware configurations, that is, may adjust a lens movement or the number of apertures according to a camera program executed by the processor 122.

The camera device 130 may provide a collection image which is acquired by photographing a subject to the processor unit 120. The camera device 130 may include an image sensor to convert an optical signal into an electric signal, an image signal processor to convert an analogue image signal into a digital image signal, and a digital signal processor to image-process the image signal output from the image signal processor to be displayed on the display device 190. Although not shown, the camera device 130 may include an actuator to move the lens, a driver IC to drive the actuator, etc.

The sensor device 140 may include a proximity sensor, a hall sensor, a luminance sensor, a motion sensor, etc. For example, the proximity sensor may sense an object approaching the electronic device 100, and the hall sensor may sense a magnetism of a metal body. In addition, the luminance sensor senses ambient light of the electronic device 100, and the motion sensor may include an acceleration sensor or a gyro sensor to sense a motion of the electronic device 100. However, this should not be considered as limiting and the sensor device 140 may further include various sensors to perform other well-known additional functions.

The wireless communication device 150 enables wireless communication and may include a Radio Frequency (RF) transmitter/receiver or a light (infrared ray) transmitter/receiver. Although not shown, the wireless communication device 150 may include an RF IC unit and a baseband processor. The RF IC unit may transmit/receive electromagnetic waves, and may convert a baseband signal from the baseband processor into electromagnetic waves and transmit the electromagnetic waves via an antenna.

The RF IC unit may include an RF transceiver, an amplifier, a tuner, an oscillator, a digital signal processor, a CODEC (COding DECoding) chip set, a Subscriber Identification Module (SIM) card, etc.

The wireless communication device 150 may be implemented to be operated via at least one of a Global System for Mobile Communication (GSM) network, an Enhanced Data GSM Environment (EDGE) network, a Code Division Multiple Access (CDMA) network, a Wideband Code Division Multiple Access (W-CDMA) network, a Long Term Evolution (LTE) network, an Orthogonal Frequency Division Multiple Access (OFDMA) network, a Wireless Fidelity (Wi-Fi) network, WiMax network, a Near Field Communication (NFC) network, an Infrared Data Association (IrDA) network, and a Bluetooth network, according to a communication network. However, this should not be considered as limiting and the wireless communication device 150 may adopt various communication schemes using protocols for an e-mail, instant messaging or Short Message Service (SMS).

The audio device 160 may be connected to a speaker 161 and a microphone 162 to perform an audio input and output function such as voice recognition, voice reproduction, digital recording, and telephony functions. The audio device 160 may provide an audio interface between the user and the electronic device 100, and may convert a data signal received from the processor 122 into an electric signal and output the converted electric signal via the speaker 161.

The speaker 161 may convert the electric signal into an audible frequency band and output the audible frequency band, and may be disposed on a front or rear portion of the electronic device 100. The speaker 161 may include a flexible film speaker in which at least one piezoelectric member is attached to a single vibration film.

The microphone 162 may convert a sound wave transmitted from a person or other sound sources into an electric signal. The audio device 160 may receive the electric signal from the microphone 162, convert the received electric signal into an audio data signal, and transmit the converted audio data signal to the processor 122. The audio device 160 may include an earphone, an ear set, a headphone, or a headset which is attachable to and detachable from the electronic device 100.

The external port device 170 may directly connect the electronic device 100 to other electronic devices or may indirectly connect the electronic device to other electronic devices via a network (e.g., Internet, Intranet, wireless LAN, etc.). The external port device 170 may include a Universal Serial Bus (USB) port, a FIREWIRE port, etc.

The input/output controller 180 may provide an interface between an input/output device such as the display device 190 and the input device 200 and the peripheral interface 123. The input/output controller 180 may include a display device controller and other input device controllers.

The display device 190 may provide an input and output interface between the electronic device 100 and the user. The display device 190 may transmit touch information of the user to the processor 122 by applying a touch sensing technology, and may show visual information, a text, a graphic, or a video provided from the processor 122 to the user.

The display device 190 may display state information of the electronic device 100, a text which is input by the user, a moving image, and a still image. In addition, the display device 190 may display information related to an application which is driven by the processor 122. Such a display device 190 may apply at least one of a Liquid Crystal Display (LCD), an Organic Light Emitting Diode (OLED), an Active Matrix Organic Light Emitting Diode (AMOLED), a Thin Film Transistor (TFT)-LCD, a flexible display, and a 3-dimensional display.

The input device 200 may provide input data which is generated by a user's selection to the processor 122 via the input/output controller 180. The input device 200 may include a keypad including at least one hardware button and a touch pad for sensing touch information.

The input device 200 may include an up/down button to control a volume. In addition, the input device 200 may include at least one of a push button, a locker button, a locker switch, a thumb-wheel, a dial, a stick, a mouse, a track-ball or a pointer device such as a stylus, which are given corresponding functions.

The memory 110 may include a fast random access memory such as one or more magnetic disc storage devices or a non-volatile memory, one or more optical storage devices, or a flash memory (e.g., NAND, NOR).

The memory 110 stores a software component. The software component includes an operating system module 111, a communication module 112, a graphic module 113, a user interface module 114, a CODEC module 115, a camera module 116, and an application module 117. The module may also be expressed as a group of instructions, an instruction set, or a program.

The operating system module 111 may include an embedded operating system such as WINDOWS® operating system, LINUX®, Darwin®, RTXC Quadros™, UNIX®, OS X®, the Android™ platform or VxWorks®, and may include various software components for controlling a general system operation. The control of the general system operation includes memory control and management, storage hardware (device) control and management, power control and management, etc. In addition, the operating system module 111 performs a function for facilitating communication between various hardware elements (devices) and software elements (modules).

The communication module 112 may enable communication with other electronic devices such as a computer, a server, and an electronic device via the wireless communication device 150 or the external port device 170.

The graphic module 113 may include various software components for providing and displaying graphics on the display device 190. The terminology of “graphics” indicates a text, a web page, an icon, a digital image, a video, an animation, etc.

The user interface module 114 includes various software components related to a user interface. The user interface module 114 may control to display information related to an application which is driven by the processor 122 on the display device 190. In addition, the user interface module 114 may include the content related to how a state of the user interface changes and in which condition the state of the user interface changes.

The CODEC module 115 may include a software component related to encoding and decoding of a video file.

The camera module 116 may include various software components for performing a camera function (e.g., taking a picture, shooting a video, etc.)

The application module 117 may include a software component for at least one application installed in the electronic device 100. Such an application may include a browser, an e-mail, a phone book, a game, a short message service, a multimedia message service, a Social Networking Service (SNS), an instant message, a morning call, an MPEG Layer 3 (MP3), schedule management, a drawing board, a camera, word processing, keyboard emulation, a music player, an address book, a contact list, a widget, a Digital Right Management (DRM), voice recognition, voice reproduction, a location determining function, a location-based service, a user authentication service, etc. The application may be expressed as an application program.

The processor unit 120 may further include an additional module (instructions) in addition to the above-described modules.

The various functions of the electronic device 100 may be executed by hardware or software including one or more processing or application specific integrated circuits (ASIC).

Although not shown, the electronic device 100 may include a power system for supplying power to the various elements included in the electronic device 100. The power system may include a power source (alternating current power source or battery), a power error detection circuit, a power converter, a power inverter, a charging device, or a power state display device (light emitting diode). In addition, the electronic device 100 may include a power management and control device for generating, managing, and distributing power.

The elements of the electronic device 100 have been illustrated and explained, but are not limited to those described above. For example, the electronic device 100 may include a larger or smaller number of elements than those illustrated in the drawing.

Referring now to the example processor of FIG. 2B, the processor 122 may include an operating system (OS) driver 220, a user input receiver 240, an authentication processor 260, and a display controller 280. In one example, the elements of the processor 122 may be separate modules. However, the elements may be included in a single module as elements of software.

The OS driver 220 may control a plurality of OSs for operating the electronic device 100 by executing the operating system module 111 stored in the memory 110.

The OS driver 220 may include an element for operating a non-trusted OS (or an open OS) for controlling a general system operation and a trusted OS for performing a function for user authentication. The trusted OS may be operated in a secure and high-security trusted execution environment such as a trusted zone.

For example, the electronic device 100 may execute an application requiring authentication; in this instance, the OS driver 220 may display a user interface for authentication by executing the non-trusted OS. In addition, the OS driver 220 may receive a user input for authentication by executing the trusted OS, and may authenticate the user input.

The OS driver 220 may operate the above-described non-trusted OS and trusted OS simultaneously and may output a user interface on display device 190. In addition, the trusted OS may control the non-trusted OS, but the non-trusted OS may not be able to control the trusted OS.

The user input receiver 240 may include instructions for receiving at least one user input for authentication. For example, the user input receiver 240 may sense a user input which is input via an inputting means, such as a touch input, a keyboard input, a mouse input, etc., which is input in the trusted execution environment, and may provide input information corresponding to the user input to the authentication processor 260. The user input receiver 240 may be operated in the trusted execution environment.

The authentication processor 260 may perform authentication by using the user input information provided by the user input receiver 240. The authentication processor 260 may perform authentication according to the user input in the trusted execution environment, and may perform authentication only through the trusted OS and the non-trusted OS may not access the trusted OS.

The display controller 280 may include instructions for displaying application information provided by the OS driver 220. The display controller 280 may output the user interface for authentication to the display device 190 as graphics. In addition, the display controller 280 may also display user interface layout information for displaying the user interface and may output a character corresponding to a number of user inputs for authentication.

In the present example, the elements of the processor 122 have been illustrated and explained, but are not limited to those described above. For example, the processor 122 may more or less components than those illustrated in the drawings. FIGS. 3A and 3B illustrate different working examples in accordance with aspects of the present disclosure.

Referring to FIG. 3A, the processor 122 may perform a non-trusted process 313 or a trusted process 323 as a processing means for various programs. The processor 122 may control to switch between a non-trusted execution environment 310 and a trusted execution environment 320 via a communication module 300. For example, the communication module 300 may enter a monitor mode by executing a monitor program. When the processor 122 is viewed from the outside, the monitor mode may always be secure and the monitor program may exist in a secure memory.

In one example, the processor 122 may execute a non-trusted OS 311 in the non-trusted execution environment 310, and the non-trusted process 313 may be processed to be operated via the non-trusted OS 311. In addition, the processor 122 may execute a trusted OS 321 in the trusted execution environment 320, and the trusted process 323 may be processed to be operated via the trusted OS 321. For example, the trusted OS 321 may provide functions necessary for processing the trusted execution environment 320.

In another example, the non-trusted process 313 may include various software components and hardware modules for driving various programs. The non-trusted process 313 may provide a secure input service for the user to securely input user information necessary for authentication. For example, when an application requiring authentication is executed, the non-trusted process 313 may control to display a user interface for authentication. Such an authentication application may be a wallet application or a bank-related application.

The non-trusted process 313 may receive input data through a user interface configured by the trusted process 323, and may output the input data to the display device 190. In addition, the non-trusted process 313 may be precluded from accessing or reading the user information input via the trusted process 323 and the user information may be detected only by the trusted process 323; in turn, the trusted process 23 may authenticate the user information.

The non-trusted process 313 may display user interface layout information for displaying the user interface, and the user interface layout information may be set in advance.

The trusted process 323 may include various software components and hardware modules for performing authentication. The trusted process 323 may receive a user input for authentication and may authenticate the user input.

In a further example, the non-trusted OS 311 may be precluded from accessing the trusted OS 321. For example, the trusted OS 321 may be completely protected from code of the non-trusted process 313 processed by the non-trusted OS 311.

Referring to FIG. 3B, processors 340 and 350 may be used to operate a non-trusted process 343 and a trusted process 353, respectively. For example, a non-trusted OS 341 may be provided via the first processor 340 and the non-trusted process 343 may be operated via the non-trusted process OS 341. In addition, a trusted OS 351 may be executed by the second processor 350 and the trusted process 353 may be operated via the trusted OS 351. Control between such individual processors 340 and 350 may be performed by a communication module 330.

Although not shown, the above-described trusted execution environment may include a memory area of a small size. Such a memory area may store security data such as a master key, a certificate, personal information, etc., and may be accessed only by the processor of the trusted execution environment 320 and may be restricted from access by the processor of the non-trusted execution environment.

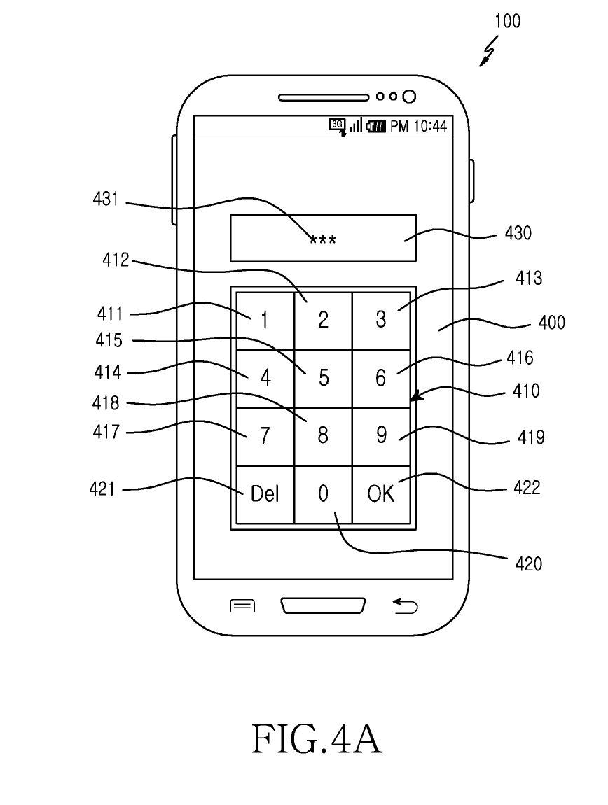

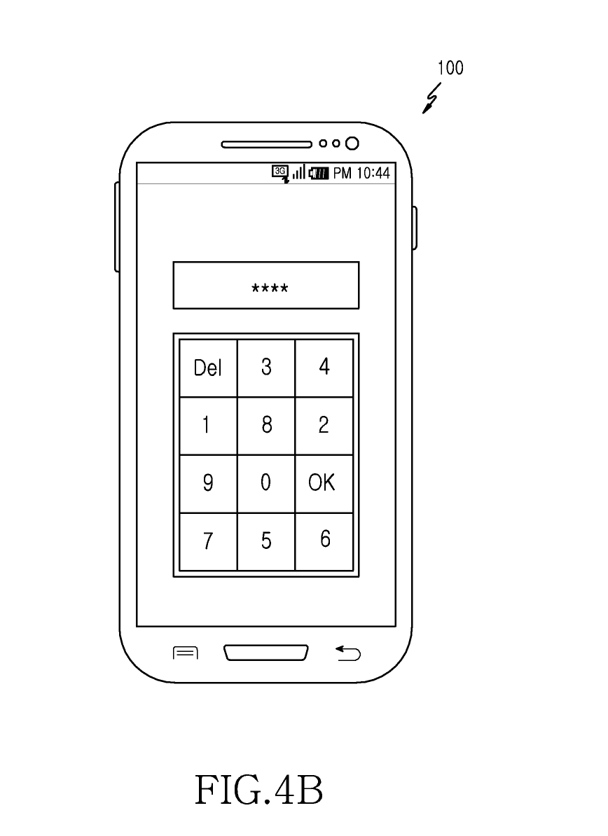

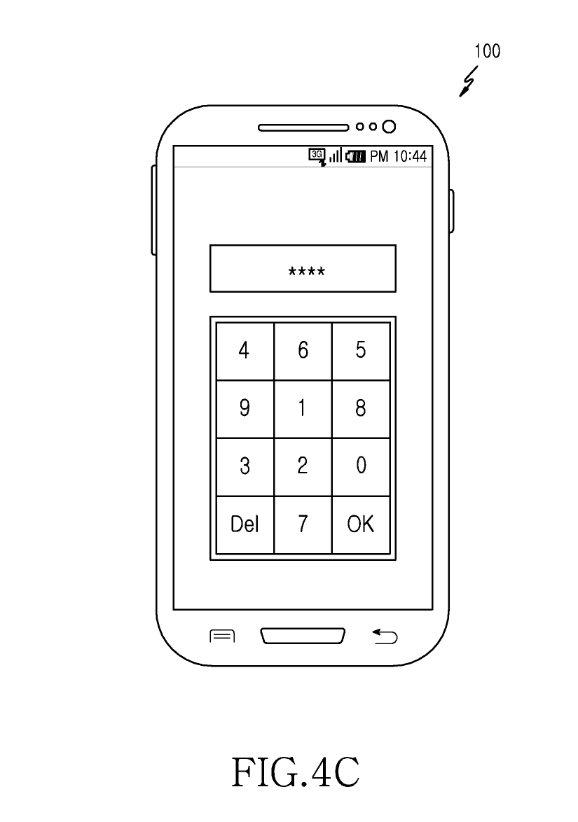

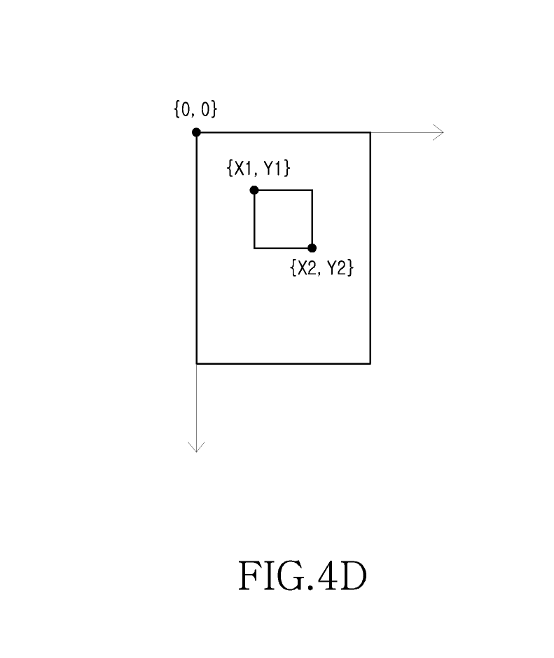

Referring now to the working example of FIG. 4A, the electronic device 100 may display a user interface 410 for authentication on a screen 400. The display of the user interface 410 may be performed in the non-trusted execution environment of the electronic device 100. The user interface 410 may be comprised of a plurality of input areas 411, 412, 413, 414, 415, 416, 417, 418, 419, 420, 421, and 422 for receiving at least one input of user information necessary for authentication. The user information security information that may include, but is not limited to, a Personal Identification Number (PIN) or credit card number.

Data values may be arranged on the plurality of input areas 411, 412, 413, 414, 415, 416, 417, 418, 419, 420, 421, and 422. Integers 1 to 3 may be displayed on the top row of the user interface 410 from left to right in sequence, and integers 4 to 6 and integers 7 to 9 may be arranged on the rows under the top row from left to right in sequence. In addition, a ‘Del’ key for deleting recently input data and an ‘OK’ key for completing a user input may be arranged on the bottom row under the row of integers 7 to 9. Electronic device 100 may randomly arrange the data values for the plurality of input areas 411, 412, 413, 414, 415, 416, 417, 418, 419, 420, 421, and 422 (see FIG. 4B).

In another example, the electronic device 100 may fix the locations of the above-described ‘Del’ key and ‘OK’ key and may randomly arrange integers 0 to 9 so that a password may be prevented from being exposed to other users (see FIG. 4C). However, this should not be considered as limiting and the input data values may be arranged in various ways. The electronic device 100 may digitally display the number corresponding to each input area (or a key), may randomly change arrangements of the numbers every time a user input for authentication is received, and may assign a different color or a different pattern to each number and may display the color or pattern at the same time in which the number is displayed.

As described above, the electronic device 100 may receive user information corresponding to an input key button. The non-trusted execution environment of the electronic device 100 may be precluded from receiving user information, and the user information may be acquired only in the trusted execution environment of the electronic device 100. For example, the user information acquired in the trusted execution environment may be used for authentication. In addition, a character 431 indicating the number of user inputs may be displayed on an indicator 430 of the screen 400. The character 431 may be ‘*’, but is not limited to this. For example, the trusted execution environment provides the number of user inputs to the non-trusted execution environment and the non-trusted execution environment may display the number of user inputs as any type of character.

As shown in FIG. 4D, the electronic device 100 may define the location of each of the input areas 411, 412, 413, 414, 415, 416, 417, 418, 419, 420, 421, and 422 of the user interface 410 by using coordinates on each of the input areas 411, 412, 413, 414, 415, 416, 417, 418, 419, 420, 421, and 422. For example, the electronic device 100 may define a rectangular area having a straight line connecting coordinates {X1, Y1} and coordinates {X2, Y2} with reference to coordinates {0, 0} as a diagonal. However, this should not be considered as limiting and the input area may be defined in various ways. For example, the shape of each input area may also be defined as a square, triangle, or a circle.

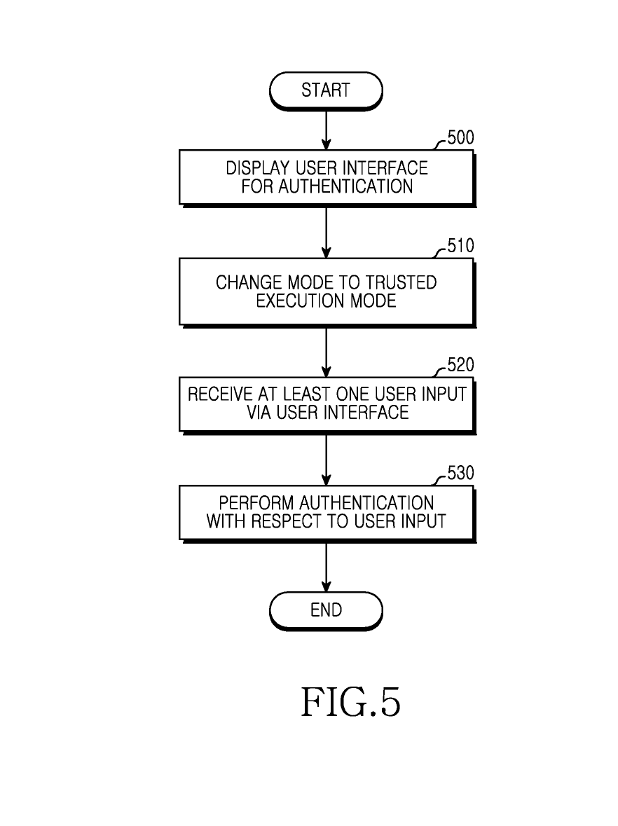

Referring now to the example method of FIG. 5, the electronic device 100 may display a user interface for authentication in operation 500. When an application requiring authentication is executed, the electronic device 100 may display the user interface 410 for receiving an input of user information as shown in FIG. 4A. For example, the display of the user interface 410 may be performed in the non-trusted execution environment of the electronic device 100. The user interface 410 may be configured in the trusted execution environment of the electronic device 100 or may be set by the user. The electronic device 100 may change a mode to a trusted execution mode in operation 510.

In another example, the electronic device 100 may be operated in the Trusted Execution Environment (TEE) or in a Non-trusted Execution Environment (NTEE). For example, the non-trusted execution environment may refer to an operating system which is used for general system control and management. Such an operating system may include, but is not limited to, the Android™ platform or Linux®. In one example, the trusted execution environment may be an operating system used when a process requiring security, such as user authentication, is performed. Such a trusted execution environment may be secure and protected from being hacked by external devices. The above-described trusted execution environment and non-trusted execution environment may be implemented not only as hardware but also as software. The electronic device 100 may change the mode to the trusted execution environment operation mode.

The electronic device 100 may receive at least one user input via the user interface in operation 520. In one example, the electronic device 100 may receive a user input such as a touch input, a keyboard input, a mouse input, etc. via the user interface 410. Such a user input may be received in the trusted execution environment. The electronic device 100 may perform authentication with respect to the user input in operation 530. The electronic device 100 may perform authentication with respect to the user input in the trusted execution environment, and may restrict access to the trusted execution environment by the non-trusted execution environment. An instruction set for each operation may be stored in the above-described memory 110 as one or more modules. In this case, the modules stored in the memory 110 may be executed by one or more processors 122.

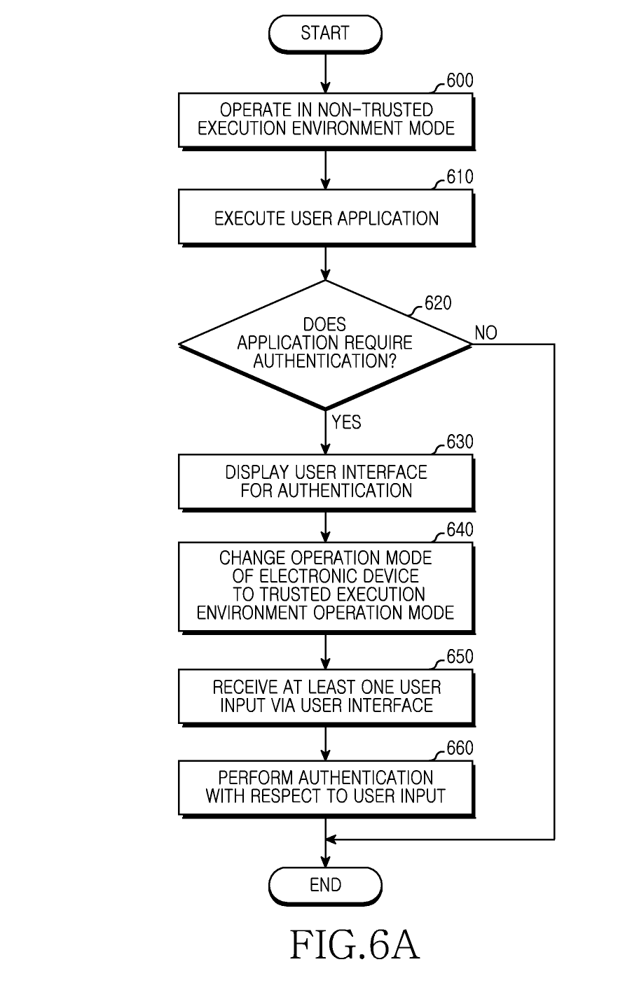

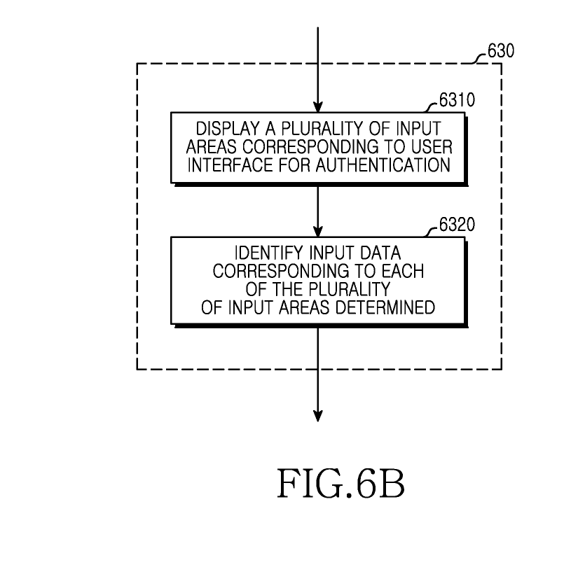

Referring now to the example method of FIG. 6A, the electronic device 100 may be operated in a non-trusted execution environment mode in operation 600. The electronic device 100 may be operated by an OS (e.g., Android™ platform or Linux®) which is the non-trusted execution environment. The electronic device 100 may execute a user application in operation 610. Electronic device 100 may select various user applications provided in the non-trusted execution environment.

The electronic device 100 may determine whether the application requires authentication in operation 620. Electronic device 100 may determine whether the application is a general application which does not require authentication or a security application which requires authentication. When the application requires authentication, the electronic device 100 may display a user interface for authentication in operation 630. When an application requiring authentication is executed, the electronic device 100 may display the user interface 410 for receiving at least one input as shown in FIG. 4A. For example, the display of the user interface 410 may be performed in the non-trusted execution environment. Operation 630 is explained in more detail below with reference to FIG. 6B.

Referring now to the example in FIG. 6B, the electronic device 100 may display a plurality of input areas corresponding to the user interface for authentication in operation 6310.

As shown in FIG. 4A, the electronic device 100 may configure a plurality of input areas 411, 412, 413, 414, 415, 416, 417, 418, 419, 420, 421, and 422 of the user interface 410 for receiving an input of user information necessary for authentication. The user information may be security information that includes, but is not limited to, a Personal Identification Number (PIN) or credit card number.

As shown in FIG. 4D, the electronic device 100 may define the location of each of the input areas 411, 412, 413, 414, 415, 416, 417, 418, 419, 420, 421, and 422 of the user interface 410 by using coordinates of each of the input areas 411, 412, 413, 414, 415, 416, 417, 418, 419, 420, 421, and 422. For example, the electronic device 100 may define a rectangular area having a straight line connecting coordinates {X1, Y1} and coordinates {X2, Y2} with reference to coordinates {0, 0} as a diagonal. However, the input area may be defined in various ways.

The electronic device 100 may identify the input data detected through each of the plurality of input areas in operation 6320. Electronic device 100 may arrange corresponding data values on the plurality of input areas 411, 412, 413, 414, 415, 416, 417, 418, 419, 420, 421, and 422. For example, integers 1 to 3 may be displayed on the top row of the user interface 410 from left to right in sequence, and integers 4 to 6 and integers 7 to 9 may be arranged on the rows under the top row from left to right in sequence. In addition, a ‘Del’ key for deleting recently input data and an ‘OK’ key for completing the user input may be arranged on the bottom row under the row of integers 7 to 9.

Electronic device 100 may randomly arrange the plurality of input areas 411, 412, 413, 414, 415, 416, 417, 418, 419, 420, 421, and 422 (see FIG. 4B). In another example, electronic device 100 may fix the locations of the above-described ‘Del’ key and ‘OK’ key and may randomly arrange integers 0 to 9 so that a password may be prevented from being exposed to other users (see FIG. 4C). However, this should not be considered as limiting and the input data values may be arranged in various ways.

In a further example, electronic device 100 may digitally display the number corresponding to each input area (or a key), may randomly change arrangements of the numbers every time the user input is received, and may assign a different color or a different pattern to each number and may display the color or pattern at the same time of displaying the number.

Referring back to FIG. 6A, electronic device 100 may change the operation mode of the electronic device 100 to a trusted execution environment operation mode in operation 640. After displaying the user interface in the non-trusted execution environment, the electronic device 100 may change the mode to the trusted execution environment operation mode.

The electronic device 100 may receive at least one user input via the user interface in operation 650. In one example, electronic device 100 may receive a user input such as a touch input, a keyboard input, a mouse input, etc. via the user interface 410 shown in FIG. 4A. Such a user input may be received in the trusted execution environment.

In one example, the non-trusted execution environment of the electronic device 100 is restricted from detecting user information, and the user information may be obtained in the trusted execution environment of the electronic device 100. For example, the user information acquired in the trusted execution environment may be used for authentication. In addition, a character 431 indicating the number of user inputs may be displayed on an indicator 430 of the screen 400 according the number of user inputs (see FIG. 4D). The character 431 may be ‘*’, but is not limited to this. For example, the trusted execution environment may provide the number of user inputs to the non-trusted execution environment and the non-trusted execution environment may display the number of user inputs as a character.

The electronic device 100 may perform authentication with respect to the user input in operation 660. Electronic device 100 may perform authentication with respect to the user input in the trusted execution environment, and may restrict the trusted execution environment from being accessed by the non-trusted execution environment. In one example, the display of the user interface for authentication is performed in the non-trusted execution environment, and the user input received via the user interface is authenticated in the trusted execution environment; in turn, the electronic device 100 may be prevented from being hacked by external devices. An instruction set for each operation may be stored in the above-described memory 110 as one or more modules. In this case, the modules stored in the memory 110 may be executed by one or more processors 122.

The above-described embodiments of the present disclosure can be implemented in hardware, firmware or via the execution of software or computer code that can be stored in a non-transitory computer readable medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

In addition, an artisan understands and appreciates that a “processor” or “microprocessor” constitute hardware in the claimed invention. Under the broadest reasonable interpretation, the appended claims constitute statutory subject matter in compliance with 35 U.S.C. §101. The functions and process steps herein may be performed automatically or wholly or partially in response to user command. An activity (including a step) performed automatically is performed in response to executable instruction or device operation without user direct initiation of the activity.

Although the disclosure herein has been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

What is claimed is:

1. A method in an electronic device, the method comprising:
displaying a user interface for authentication while in a non-trusted execution mode;
changing an execution mode of the electronic device to a trusted execution mode;
detecting at least one input via the user interface while in the trusted execution mode; and
authenticating the at least one user input while in the trusted execution mode.

2. The method of claim 1, further comprising configuring a plurality of input areas on the user interface that permits the at least one input to be entered, while in the trusted execution mode.

3. The method of claim 2, wherein the at least one input corresponding to each of the plurality of input areas constituting the user interface is identified while in the trusted execution mode.

4. The method of claim 2, wherein configuring the plurality of input areas of the user interface is based at least partially on the at least one input detected via the plurality of input areas.

5. The method of claim 4, wherein the input area is determined by coordinates.

6. The method of claim 4, wherein the input area comprises at least one shape of a rectangle, a square, a triangle, and a circle.

7. The method of claim 4, wherein the at least one input is detected sequentially.

8. The method of claim 4, wherein the at least one input is received randomly.

9. The method of claim 4, wherein some of the input areas are arranged in a fixed pattern and some of the input areas are arranged in a sequential or random pattern.

10. The method of claim 4, wherein an arrangement of the plurality of input areas is changed randomly when the at least one input is detected or a color of the at least one input is changed when the at least one input is detected.

11. The method of claim 1, wherein a layout of the user interface for displaying the user interface is set in advance.

12. An electronic device which operates a trusted execution environment and a non-trusted execution environment, the electronic device comprising:
at least one processor to;
display a user interface for authentication while in a non-trusted execution mode;
change an execution mode of the electronic device to a trusted execution mode;
detect at least one input via the user interface while in the trusted execution mode; and
authenticate the at least one user input while in the trusted execution mode.

13. The electronic device of claim 12, wherein the at least one processor is further configured to identify a plurality of input areas on the user interface that permits the at least one input to be entered, while in the trusted execution mode.

14. The electronic device of claim 13, wherein, to identify the plurality of input areas, the at least one processor to identify the plurality of input areas based at least partially on the at least one input detected.

15. The electronic device of claim 14, wherein the at least one processor is further configured to identify the input area by coordinates.

16. The electronic device of claim 14, wherein the at least one processor is further configured to arrange some of the input areas in a fixed pattern and arrange some of the input areas in a sequential or random pattern.

17. The electronic device of claim 14, wherein the at least one processor is configured to change an arrangement of the plurality of input areas randomly when the at least one input is detected or change a color of the at least one input when the at least one input is detected.

18. The electronic device of claim 14, wherein the at least one processor identifies the at least one input corresponding to each of the plurality of input areas constituting the user interface while in the trusted execution mode.

19. The electronic device of claim 12, wherein the at least one processor is configured to set a layout of the user interface in advance.

20. A non-transitory computer readable medium with instructions stored therein which upon execution instruct at least one processor to:
display a user interface for authentication while in a non-trusted execution mode;
change an execution mode of the electronic device to a trusted execution mode;
detect at least one input via the user interface while in the trusted execution mode; and
authenticate the at least one user input while in the trusted execution mode.
